(19) United States
(12) Patent Application Publication
(10) Pub. No.: US 2015/0276025 A1
(43) Pub. Date: Oct. 1, 2015

(54) Cylindrical Cam Lock Jackshaft System

(71) Applicant: Donald Barton Grube, Bokchito, OK (US)

(72) Inventor: Donald Barton Grube, Bokchito, OK (US)

(73) Assignee: Donald Barton Grube, Bokchito, OK (US)

(21) Appl. No.: 14/711,812

(22) Filed: May 14, 2015

Related U.S. Application Data
(63) Continuation-in-part of application No. 12/792,848, filed on Jun. 3, 2010, now abandoned.

(51) Int. Cl. F16H 7/16

(52) U.S. Cl. CPC F16H 7/16; F16H 2007/0865

(57) ABSTRACT

A timing belt (T belt) power control system consists of an engine external centrifugal clutch and integral bell drum, a small T belt drive pulley affixed to said bell drum, an automotive type timing belt, a large driven pulley for speed reduction and torque enhancement having a one-way freewheel bearing hub riding on a output jackshaft or if with solid hub having a jackshaft with a primary output drive 9 to 12T freewheel sprocket, a ball bearing supported said output jackshaft with primary drive sprocket for chain operation, a non-concentric jackshaft location in a cylindrical housing that holds the said driven pulley. T Belt tension is secured and maintained by rotating the cam lock assembly with a spanner wrench and then held tight by four bolts which eliminates the need for a belt tensing or spring loaded pulley.

This application is a continuation-in-part application of U.S. patent application Ser. No. 12/792,848 filed 3 Jun. 2010, which claims priority to U.S. Patent Application Ser. No. 61/219,461 filed 23 Jun. 2009.

### TECHNICAL FIELD OF THE INVENTION

This invention relates to a gasoline internal combustion four-cycle engine power-assisted vehicle, in which a horizontal shaft engine is utilized to self propel a vehicle, particularly but not exclusively a bicycle, a tricycle, a go-cart, a paddle boat and similar vehicles, and to its application being extended to a stationary engine work station utilized to chain drive a work wheel or driven axle requirement.

### BACKGROUND OF THE INVENTION

In developed countries, bicycling, go-carting and pedal boating are enjoying preferred outdoor activities by many people, both are pleasant and healthful exercises. Riding a bicycle for short distance to one's work locations is environmentally friendly transportation and less expensive than commuting by car, SUV or pickup truck using high fuel consumption. Therefore, it is not surprising that bicycles and tricycles are utilized as dominant means of transportation in developing countries especially in rural and remote areas and represent a market challenge for motorizing said vehicles. Light weight vehicles such as a motorized bicycle have a niche market place below that of motorcycles and commercial mopeds. Even in developed countries that are experiencing high fuel cost alternative modes of transportation are becoming increasing popular such as bicycles, mopeds, scooters, and motorcycles.

Conventional vehicles such as bicycles, tricycles, pedal carts and paddle boats are limited by their human-power abilities. Some people cannot pedal a bicycle, tricycle while others become tired easily especially in mountainous or hilly areas. It is difficult to pedal a paddle wheel boat for long distance or up stream in a rapid flowing stream that might also be dangerous to such users.

Several variations of basic motorized bicycle gasoline engine kits have been developed for end users in the prior art. Some of these engine kits incorporate two-cycle gasoline engines using oil/gasoline mixture that have high exhaust air pollution resulting from mixing oil and gasoline in combustion. Most of these 2 cycle type engines have been imported from China. Other prior art motorized bikes incorporate rudimentary exposed V belt or chain drives with engines mostly mounted over the rear wheel or inside the frame and without any way to mechanically disengage engine power at rpm above clutch operation without killing the engine. Prior art includes a related U.S. patent application Ser. No. 11/428,539 invented by Donald Barton Grube who is the same inventor on record as with this T Belt power transmision control system.

There exists some electric motor-based bicycles but they have limited low power for hill-climbing and the inability to recharge batteries away from electrical outlets. Gas stations remain the most prevalent present source for vehicle refueling in the USA. The design of a light weight 2 cycle gasoline engine to motorize a standard V frame bicycle and also meet EPA regulation for exhaust emission on vehicles heavier than 20 kg. in the prior art are too complex and costly to manufacture. The present invention utilizes a standard light weight four-cycle gasoline engine EPA approved and readily available in the Original Equipment Manufacture known as OEM, and also in the aftermarket. The present invention provides an end user a way to motorize a vehicle or motorize a stationary machine by using a standard EPA approved easily obtainable aftermarket high rpm four-cycle gasoline engine without any modification. As further recognized by the present invention, it is an accoutrement apparatus component that enables the end user to apply a small four-cycle gasoline engine to a chain drive work related wheel type load requirement and gain gear reduction speed and torque with the benefit of engine power engagement control. The object of this present invention is to provide a power control transmission system to motorize a vehicle or stationary machine by utilizing a centrifugal clutch and an automotive engine type rubber timing gear belt to transmit torque from the centrifugal clutch pulley to a larger driven pulley and on to an output shaft. Said timing belt has it's tension adjusted by a rotating a non concentric cam housing that holds the driven pulley shaft thus gaining the advantage of safety and complete control of engine engagement without the clumsy addition of a spring loaded belt slack adjuster. Another object of the present invention is to provide a practical way to drive a work related wheel or axle load requirement, but not exclusively limited to, motorizing bicycles, motorizing tricycles, motorizing paddle wheel boats, and motorizing pedal go carts for on road or off road use.

### SUMMARY OF THE INVENTION

A motorized vehicle is disclosed by typical exemplification that includes a standard bicycle V frame or a modified bicycle V frame having a front wheel and a rear wheel attached thereto and a seat for people pedaling a chain wheel sprocket. A small four-cycle gasoline engine with displacement from 30 cc to 80 cc is mounted in the middle of the bicycle V frame or can be mounted over the rear wheel. The invention is disclosed as a centrifugal clutch timing belt power transmission Control System, hereafter referred to simply as the T Belt Power Control System.

Centrifugal Clutch in this invention is defined as a devise consisting of Rotor and Bell Drum. Abbreviations CC in this document here-after refer to Centrifugal Clutch. OEM CC abbreviation means Original Equipment Manufacture Centrifugal Clutch supplied integral with engine. The CC rotor consist of three padded shoes attached to springs that are able to expand outwardly in a CCW circular motion when subjected to RPM great enough to overcome their static position. The CC rotor is affixed on the end of engine crankshaft. Latch speed is that RPM when the three Rotor shoes are able to expand sufficiently to engage the bell drum ID and transmit engine torque from the crankshaft. The CC bell drum with drive pulley is described as a steel cup shaped devise on a shaft supported by ball bearings if used with a engine having an integral OEM supplied CC or can be supported an oil impregnated bronze bushing commonly called Oil Lite in the mechanical trade if it is on a straight shaft engine. Said bell drum and drive pulley are considered part of the T Belt Power Control System invention when made integral with the cast aluminum housing when used with a four cycle engine having the centrifugal clutch rotor supplied with the engine such as a 49 cc Huasheng 142F-1G. If the bell drum and drive pulley are not made integral as would be required on some straight shaft engines such as a 50 cc Honda GXH50 engine the bell drum and drive pulley would not be considered as part of said invention but none the less important in the operation of said invention.

Timing Gear Belt is defined as same as used in existing automotive engine state of the art for the purpose of engine valve train operation. Said timing gear belt in some manufactures text is referred to as a “Synchronous T type Belt”. The belt used in this invention is a standard rubber timing belt available in different lengths to work with different driven pulleys from 100T to 80T diameters.

Moped defined: A small four-cycle gasoline engine from 30 cc to 150 cc displacement is mounted in the middle of a bicycle V frame like found on 24 to 26″ beach cruiser bikes or the engine can be mounted over the rear wheel on a steel rack. The T belt power control system having a centrifugal clutch bell drum with drive pulley supported on a ball bearing shaft made integral with support plate housing is installed on said four cycle engine output shaft having a three centrifugal shoe rotor and working in conjunction with a T Belt to a step down ratio large driven pulley. The T belt power control system may or may not have a lever controlled integral engager system. Said engager system is not part of this patent application. The T Belt power control assembly is attached to an engine power take off (PTO) drive mounting flange with four bolts. A drive chain attaches to the output jackshaft of the T belt power control system via a small primary drive sprocket and goes to a much larger sprocket mounted on the rear axle of a standard 24″ to 29″ bicycle. This application is commonly referred to as a “moped” because it can be pedaled with engine off or operated with engine running and pedal assisted if need be.

A motorized vehicle is further disclosed that includes a tricycle frame, commonly refer to as a Rickshaw or a modified or standard tricycle frame having a front wheel and two rear wheels attached thereto and a seat for people pedaling a chain wheel sprocket. A small four-cycle gasoline engine from 30 cc to 150 cc displacement is mounted in the middle of the rickshaw or tricycle V frame. The T belt power control system having a centrifugal clutch bell drum with drive pulley supported on a ball bearing shaft made integral with support plate housing is installed on a four cycle engine power take off (PTO) output shaft having a three centrifugal shoe rotor and working in conjunction with a T Belt to a step down ratio large driven pulley. The T belt power control system may optionally include an integral engager system or may be used without an engager system. The T Belt power control assembly is attached to an engine power take off (PTO) drive mounting flange with four bolts. A drive chain attaches to the output jackshaft of the T belt power control system via a small primary drive sprocket and goes to a much larger sprocket mounted on the rear axel of the tricycle.

Moped function referred to above incorporates a gasoline engine that can be pedal started, electric started or rope pull started and then powers the driven bicycle wheel to propel the rider. The driven wheel can be operated in different modes with engine on or off.

i.) Moped engine off mode: The driven wheel of the T-belt control system can freewheel coast and can allow the bicycle to be people pedal driven without any extra felt friction. ii.) Moped engine on mode: With the engine running at a RPM sufficiently high enough to latch the CC with the bell drum the engine will then transmit torque to the T-belt drive pulley and on to the driven pulley on down to the jackshaft to the output 9 to 12T sprocket drive having a chain going to a rear wheel sprocket. iii) operator control: Operator has full control to engage power or to disengage engine power by turning the engine rpm up to engage power or down to disengage engine power all of which is due to the CC operation and the driven pulley freewheeling when in disengage mode or lock up in the engaged mode, an important safety and engagement enhancement advantage; iv.) Engine running with the rear wheel held up off the ground in a wheel stand allows for carburetor adjustments at high engine rpm.

A motorized vehicle is further disclosed that includes a paddle boat normally found as a personal pleasure small boat incorporating one to four people seats. A small four-cycle gasoline engine is mounted to the boat framework. The small four-cycle gasoline engine from 30 cc to 200 cc displacement is mounted in the boat framework. The T belt power control assembly having a centrifugal clutch bell drum with shaft drive primary drive pulley installed as an assembly on a engine power take off (PTO) output shaft having a three centrifugal shoe rotor and working in conjunction with T Belt power transmission to optionally include or not include a lever controlled integral engager system. The T Belt power control assembly is attached to an engine accessory drive mounting flange with four bolts. A drive chain attaches to the output jackshaft of the T belt power control system via a small primary drive sprocket and goes to a much larger sprocket mounted on the boat paddle wheel shaft.

A motorized vehicle is further disclosed as being a go-cart having four wheels on two axels, a steering wheel and seat for the operator and or a passenger. A go-cart may be in many configurations and work applications to include light cargo hauling or for people transportation. A small gasoline engine is mounted to the go cart frame. A small four cycle gasoline engine from 30 cc to 200 cc displacement is mounted in the go-cart framework. The T belt power control assembly having a centrifugal clutch bell drum with shaft drive primary drive pulley installed as an assembly on an engine power take off (PTO) output shaft having a three centrifugal shoe rotor and working in conjunction with a T Belt power transmission to optionally include or not include a lever controlled integral engager system. The T Belt power control assembly is attached to an engine accessory drive mounting flange with four bolts. A drive chain attaches to the output jackshaft of the T belt power control system via a small primary drive sprocket and goes to a much larger sprocket mounted on the rear axel of the go-cart.

A stationary engine work station can be further disclosed as work station requiring small four-cycle engine to turn an axel shaft such as would be typicality found using a circle saw to cut wood but not exclusively. A small four-cycle gasoline engine from 30 cc to 200 cc displacement is mounted on the work station frame. The T belt power control assembly having a centrifugal clutch bell drum with shaft drive primary drive pulley installed as an assembly on a engine output shaft having a centrifugal 3 shoe rotor and working in conjunction with a T Belt power transmission to optionally include an integral lever controlled engager system if required. The T Belt power control assembly is attached to an engine power take off (PTO) outing flange with four bolts. A drive chain attaches to the output jackshaft of the T belt power control assembly via a small primary drive sprocket and goes to a much larger sprocket mounted on the rear axel of the intended work load requirement such as on an grain elevator or wood cutting saw but not exclusively.

To be able to use an off the shelf aftermarket EPA approved high tech four-cycle small gasoline engine of normally 30 cc to 200 cc displacement, but not limited to, said displacement for applications requiring a driven wheel to do work with a reduced ratio speed, thus gaining a torque enhancement ratio and have complete control with or with a lever controlled engager system that is remote controlled by steel cable and lever. Such applications can be, but not exclusively limited to, motorizing bicycles, tricycles, paddle boats, and pedal go carts. Engine running without a lever controlled engager can be have the rear wheel held up in a wheel stand off the ground which can allow for high rpm engine operation for carburetor adjustments. Said lever controlled engager system is covered by U.S. Pat. No. 7,591,202 in a gear box arrangement belonging to this inventor.

### BRIEF DESCRIPTION OF THE DRAWINGS

The present invention will be understood more fully from the detailed description of the preferred embodiments given below, from the appended claims and from the accompanying drawings. The description of specific embodiments are used to explain and understand the invention, should not be taken to limit the scope of the invention.

FIG. 1 is a typical exemplification of the invention denoted as TBPCS as would be applied on an engine in a bicycle frame. Other applications that could be utilized would work in the same manner as on a bicycle. FIG. 1 shows the TBPCS application with and without an engager system.

FIG. 2 shows the preferred embodiments collect in one Figure. The Centrifugal Clutch shown as 12. Driven pulley 6 with a one-way ball bearing or freewheel 35. Drive Timing Belt 29; the non concentric cam lock 4 for Pulley 6 on a jackshaft which serves as a way to tighten said drive timing belt 29 without using an idler pulley of any kind. A spanner wrench 20 is used to rotate the cam lock 11. The spanner wrench is stored on or about the donor vehicle or the applied machine for use as required.

FIGS. 3 and 6 shows invention as an assembly view with a belt guard cover 7 over the timing belt and held securely with three brackets and bolts.

The belt tension is adjusted by rotating the cam lock 4 or 4-1 with a spanner wrench 20 as shown in FIG. 3. When the T belt is sufficiently tight four bolts secure the pulley cam lock assembly to the power control system transmission plate 1 or 1-1.

FIG. 4 is a Section AA showing the invention without an engager system and in two variations: One is for engines with an OEM built in or integral centrifugal clutch on the end of crankshaft and one for straight shaft engines having no included centrifugal clutch. The T belt power control assembly parts consists of steel or aluminum housing plate 1 or 1-1, Bell drum 2 or 32, a drive pulley 3 and a cylindrical cam lock assembly 4, 4-1 or 4-2, Timing belt 29 and jackshaft 5,5A, or 15B riding on two ball bearings. FIG. 4. shows the T belt power control system can also work on a straight shaft engine having a three shoe rotor and bell drum with pulley both affixed to the end of the crankshaft. In this case the bell drum rides on a bronze bushing instead of affixed to a ball bearing supported shaft as with the integral version. This type centrifugal clutch system operation is also described in the inventor's patent U.S. Pat. No. 7,591,202 and is used on engines like the Honda GXH 50 or 142F HuaSheng horizontal straight shaft engines having a threaded hole and key way.

FIG. 5 shows 2 engines, one with a typical state of the art four cycle vertical cylinder horizontal output shaft CCW rotation engine having an integral OEM three-pole shoe rotor centrifugal clutch affixed to the crankshaft. The other is a straight shaft engine without a OEM supplied centrifugal clutch. FIG. 5 shows the output shaft center lines called out as CL and the four bolt accessory drive mount flange threaded holes 25 for attaching the T belt power control system 1.

FIG. 6 shows a typical four cycle engine with said invention installed and cover guard 7 in place.

FIG. 7 shows said invention with cover guard 7 removed thus revealing the T Belt drive train going to driven pulley 6. FIG. 6 Cover on and FIG. 7 Cover off;

FIG. 8 shows a typical 3 shoe centrifugal clutch rotor 12 which may or may not come with the engine depending on make and model.

FIG. 9 exploded view shows the parts of a T belt power control transmission applicable for an engine with a Centrifugal Clutch (CC) supplied OEM integral with engine.

FIG. 10 shows the parts of a T belt power control transmission applicable for an engine with a straight shaft without a Centrifugal Clutch (CC).

### DETAILED DESCRIPTION OF THE PREFERED EMBODIMENTS

### Example 1

A motorized bicycle is disclosed as an exemplification that includes a standard bicycle V frame or a modified bicycle V frame having a front wheel and a rear wheel attached thereto and a seat for people pedaling a chain wheel sprocket. A small four-cycle gasoline engine with displacement from 30 cc to 80 cc is mounted in the middle of the bicycle V frame. The invention is disclosed as a centrifugal clutch timing belt power transmission control system, hereafter referred to as T belt power control system. The T Belt power control system having a prior art three-shoe centrifugal clutch rotor installed on a engine output crankshaft and working in conjunction with said invention. The T belt power control assembly is attached to an engine's four-bolt accessory drive mounting flange. A drive chain that goes to a sprocket mounted on the left side of the rear wheel attaches to the T belt power control system via a 9 to 12T output drive sprocket affixed to the end of a jackshaft going to a T belt driven pulley.

The drawings of FIGS. 1 through 10 are used to interpret the present invention with specification description but not used to limit the scope of the invention.

FIG. 1. is a typical state of the art bicycle frame such as may be used to hold a small four cycle engine b on a slide adjustable bracket f whereby an end user could attach a T belt power control system (TBPCS) to said engine. The T Belt power control system is held together by a cast aluminum housing plate as an integral assembly.

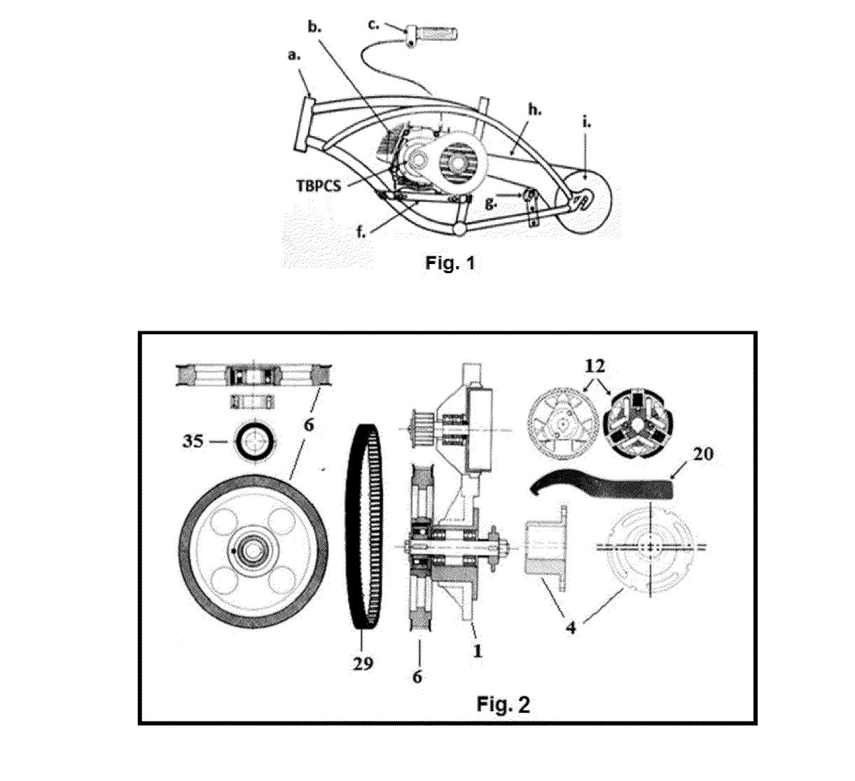

FIG. 2 shows the important embodiment parts; Driven pulley with a one-way freewheel bearing, Timing belt, and a non concentric Cam Lock for belt tensioning.

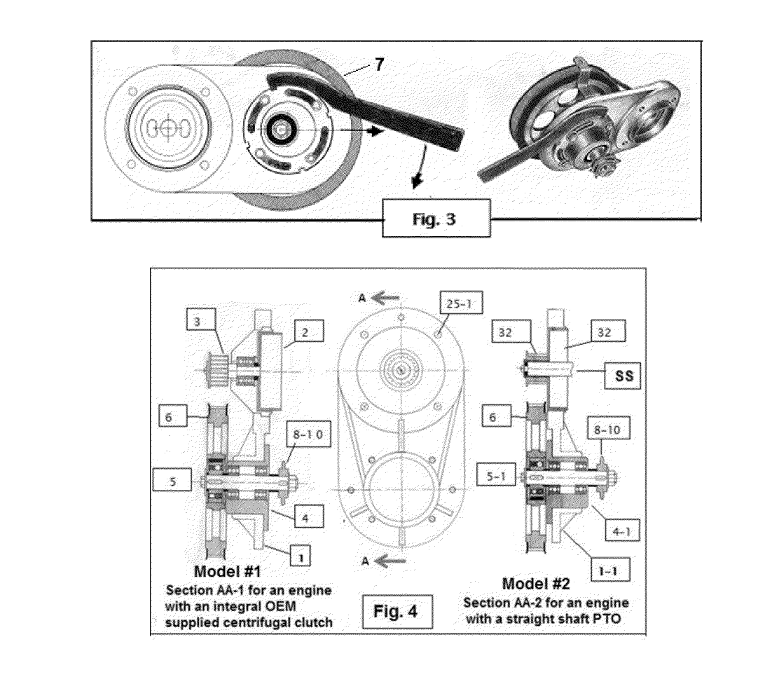

FIG. 3 shows an isometric view and 2D view of the T Belt power control system and how a spanner wrench is used to tighten belt tension by rotating the non concentric Cam Lock.

FIG. 4. Let it be noted that CC 12 in FIG. 8 is not part of this invention but is require to work in concert by latching with a bell drum rotor 3 or 32 thus driving a small drive pulley that in conjunction with a T belt can drive a larger pulley 6 attached to shaft 5 or 5-1 riding on two-ball bearings. FIG. 4. Section views shows the CC drum bells 3 and 32 required in this invention as well as the chain drive sprocket 8-10 which can be supplied in various number of sprocket teeth from nine to twelve (9-12).

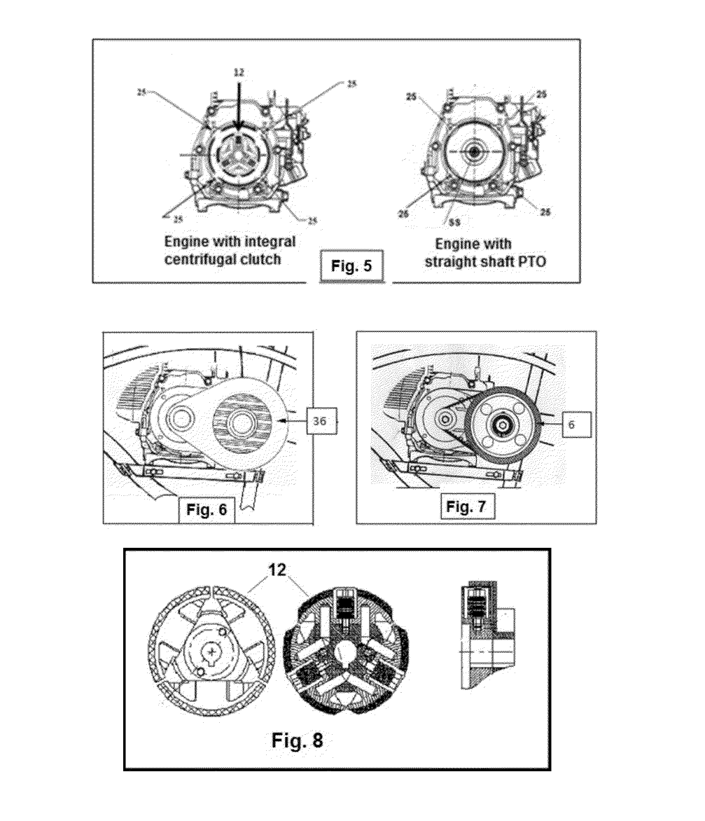

FIG. 6 shows two typical state of the art four cycle vertical cylinder horizontal output shaft CCW rotation engines used with said invention. One engine having an integral OEM three-pole shoe rotor centrifugal clutch affixed to the crankshaft and one engine with a straight shaft OEM supplied without any centrifugal clutch. FIG. 6 shows the output shaft center lines called out as CL and the four bolt accessory drive mount flange threaded holes 25 for attaching the T belt power control system, TBPCS.

FIG. 6 Shows a typical four cycle engine with said invention installed and cover guard 7 in place.

FIG. 7 Shows said invention with cover guard 36 removed thus revealing the T Belt drive train going to driven pulley 6.

FIG. 8 A prior state of the art three-shoe centrifugal clutch rotor #12 which can be part of a four-cycle engine integral or an aftermarket add on part to an engine having a straight shaft.

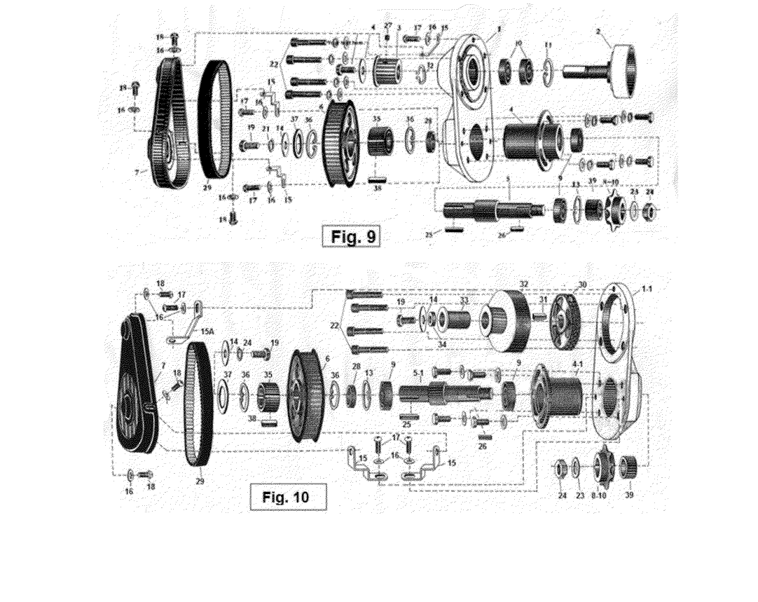

FIG. 9 shows the parts of a T belt power control transmission applicable for an engine with an integral Centrifugal Clutch (CC) supplied with engine as OEM. The items shown in exploded view FIG. 9 consist of the following reference numbers and descriptions: Housing bracket 1, Centrifugal clutch bell and shaft 2, Drive pulley 3, Pulley cam housing 4, jackshaft 5, Driven Pulley 6 with one-way bearing, Plastic cover guard 7, Chain sprocket 8, Ball bearing 9, Ball bearing 10, Ball bearing 11, Snap ring retainer 12, Snap ring retainer 13, Flat washer 14, Bracket arm to hold plastic cover guard 15 (set of three), Washer 16, Screw 17 attached by bracket, Screw cover attach 18, Bolt 19 attached by pulley, Flat washer 20, Lock washer 21, Transmission attach bolt, set of four 22, Washer 23, Nut for sprocket 24, Key for driven pulley 25, Key for chain sprocket 26, Set screw for drive pulley 27, Spacer for pulley 28, Drive T Belt 29, One-way bearing for driven pulley 35, Snap ring retainer 36, Spacer ring 37, 38, Key 38, Spacer for chain sprocket 39.

FIG. 10 shows the parts of a T belt power control transmission applicable for an engine with a straight shaft and having no Centrifugal Clutch (CC) supplied with engine. The items shown in exploded view FIG. 10 consists of the following reference numbers and descriptions. Housing bracket 1, Pulley cam housing 4, jackshaft 5, Driven Pulley 6 with one-way bearing, Plastic cover guard 7, Chain sprocket 8, Ball bearing 9, Ball bearing 10, Ball bearing 11, Snap ring retainer 12, Snap ring retainer 13, Flat washer 14, Bracket arm to hold plastic cover guard 15 (set of three), Washer 16, Screw 17 attached by bracket, Screw cover attach 18, Bolt 19 attached by pulley, Flat washer 20, Lock washer 21, Transmission attach bolt, set of four 22, Washer 23, Nut for sprocket 24, Key for driven pulley 25, Key for chain sprocket 26, Set screw for drive pulley 27, Spacer for pulley 28, Drive T Belt 29, Centrifugal clutch 30, Key 31, Clutch bell and drive pulley 32, Oil-lite Bushing 33, Spacer 34 One-way bearing for driven pulley 35, Snap ring retainer 36, Spacer ring 37, Key 38, Spacer for chain sprocket 39.

In summary of above descriptions, the T belt power control system, TBPCS, includes five essential components or embodiments:

1-A.) A cast aluminum or steel housing #1 or #1-1 holding an integral centrifugal clutch bell drum and shaft driven pulley 3 to be attached to a small vertical single cylinder four-cycle engine horizontal output shaft using four-bolt holes 25. It should be clearly noted and well understood that should a T belt power control system must fit two kinds of engine output drives. One application is with an engine having an integral OEM supplied three-shoe centrifugal clutch rotor that comes standard with the engine and the bell drum drive made integral with the T-belt power system and the other application is with an engine having a straight output shaft and no centrifugal clutch supplied with the engine. Therefore, this invention can be made such as to not have the centrifugal clutch bell drum integral with the T-belt power system housing as reference by FIG. 4 right hand view. In this case the centrifugal clutch and bell drum are affixed to the engine's straight shaft with the T belt installed on a small drive pulley 32 solidly affixed to a bell drum riding on an Oil lite bushing or needle bearing.

2-B.) A cylindrical cam lock assembly made of steel or cast aluminum; (4 or 4-1 or 4-2), holding a jackshaft in a off center position is inserted in a sleeve hole in the housing plate either #1 or #1-1. The T-belt drive power train is used to transmit power in a step down speed ratio depending on diameter of pulleys and application required.

3-C.) When used with an engine having an integral Centrifugal Clutch Rotor the clutch bell drum 2 and T belt drive pulley 3 are integral with housing plate 1. When the engine is operating above a specified rpm usually about 2600 to 3000, the centrifugal clutch rotor on the engine engages or latches with the integral bell drum 2 and via pulley 3 transmits engine torque by way of T belt drive 29 to a larger driven pulley 6 having an output jackshaft 5 with an affixed chain drive sprocket 8-10 on the inboard end.

4-D.) A plastic cover 7 is used to enclose the T Belt drive mechanism. It is held on by 3 brackets and screws and serves to protect the operator from getting tangled in a live running belt.

Installation and operation: The T belt box power control system 1 is attached to the engine by four mounting bolts going to four holes 25 FIG. 6 in the engine.

The T belt power control system, TBPCS, includes in kit form all above major parts or assemblies as received by the end user in one cardboard box.

Installation step one: Determine what engine is to be used either an engine with an OEM supplied integral CC or one having a straight shaft and no included CC then pick the appropriate T-Belt power control system TBPCS as shown in FIG. 11 and in FIG. 12. Model #1 for an engine with OEM integral supplied CC and Model #2 for a straight shaft engine without any OEM supplied CC. The CC rotor and Bell drum dive pulley are both included with Model #2. The engine manufacture nomenclature will describe the POWER TAKE OFF hence called PTO as either supplied with a CC or having a straight shaft without CC.

Installation step two. Verify the engine chosen has correct size matching centrifugal clutch rotor and correct bolt pattern to attach the T belt drive power control system TBPCS kit either Model #1 or Model #2 that you have. An instruction sheet included with said T-Belt Power control system kit denotes what brand and model number engines work best. Mount the selected engine on a frame member a or vehicle of choice using a slide adjustable mounting plate f supplied in the T-Belt Power control system TBPSC kit. as illustrated in FIG. 1.

Installation step three A: >If using Model #1 T-Belt Power control system attach the housing plate 1 with four bolts to a pre-selected small vertical single cylinder four-cycle horizontal output shaft engine as shown in the left hand view of FIG. 5 having a three-shoe OEM supplied centrifugal clutch rotor, (CC). The bell drum and drive pulley being part of the Model #1 T-Belt power control system will fit over the centrifugal clutch rotor.

Installation step three B: :If using Model #2 T-Belt Power control system first attach the kit supplied Centrifugal Clutch, (CC), and Bell rotor with bushing held in place with key and bolt on the engine PTO straight shaft. The seoarate Centrifugal clutch rotor and bell drum with affixed drive pulley are included with Model #2 kit. Next attach the housing plate 1-1 with four bolts to the pre-selected small vertical single cylinder four-cycle horizontal straight shaft output (PTO) as shown in the right hand view of FIG. 5.

Installation step four: Use the included spanner wrench to adjust belt tension leaving about ¼″ slack play in the belt so as to not preload the engine with excessive power train parasitic load.

Installation step five: Install the drive chain on sprocket 8-10 and attach the plastic cover 7 to housing plate 1 or 1-1. The cover 7 is supported and held in place by three bracket legs all held in position with screws. Ref. FIG. 6.

Operation Sequencing

A primary drive chain sprocket 8-10 is affixed to the outboard end of the jackshaft 15B for the engine output to go to the applied driven wheel of the vehicle or stationary machine as required by the end user; The workload chain can be a standard bicycle chain or a heavier 415 size chain but not exclusively. The width of the primary drive chain sprocket and the number of teeth 9-12 can be varied to make model variations for different sizes of drive chains as well as final drive ratios desired.

The T belt power control system (TBPCS) enables a drive chain h to operate a work load requirement such as chain wheel sprocket i shown in FIG. 1 in a step down speed ratio and thus enabling a small displacement engine to do efficient work. A prior art chain idler g can provide chain tension adjustment for the drive chain h.

The T belt power control system (TBPCS) has two operator controlled modes (A) and (B) when the engine is running:

A) engine running at idle rpm: At engine idle the centrifugal clutch in either Model #1 or Model 2 is not engaged with the bell drum 2 or 32 so no engine power is transmitted to the T belt power control system (TBPCS).

B) engine running above idle rpm: As the operator increases engine rpm by opening a throttle, C, the centrifugal clutch will latch to the bell drum at a predetermined speed usually 1600 to 3000 rpm depending on make and model of engine. When this happens power is transmitted to the T belt Power control system (TBPCS) and on to the desired vehicle or load requirement.

C) Engine off, not running mode: When the engine is not running a one-way bearing or freewheel in the driven pulley, 6, can allow the desired application load wheel to turn normally and not experience any patristic load restriction such as when pedaling a bicycle with engine off. For the sake of clarity a one-way bearing or freewheel spins freely in one rotational direction and locks up tight in the opposite direction.

### Example 1

A motorized bicycle or tricycle is further disclosed that includes a modified or standard V frame having a front wheel and one or two rear wheels attached thereto and a seat for people pedaling a chain wheel sprocket. A small four-cycle gasoline engine from 30 cc to 150 cc displacement is mounted in the middle of said V frame. The T-Belt power control system having a centrifugal clutch and a drum bell with primary drive pulley to be installed as an assembly on an engine PTO flange and working in conjunction with a T-belt drive train. The T belt power control system assembly is attached to an engine PTO drive mounting flange with four bolts. A drive chain attaches to the output jackshaft of the T belt power control system via a small primary drive sprocket and goes to a much larger sprocket mounted on the rear axel of the Bicycle or tricycle.

### Example 2

A motorized paddle boat is further disclosed that includes a paddle boat normally found as a personal pleasure small boat incorporating one to four people seats. A small four-cycle gasoline engine is mounted to the boat framework. The small four-cycle gasoline engine from 30 cc to 200 cc displacement is mounted in the boat framework. The T belt power control system having a centrifugal clutch bell drum and primary drive pulley to be installed as an assembly on an engine PTO output flange. The T belt power control assembly is attached to an engine PTO drive mounting flange with four bolts. A drive chain attaches to the output jackshaft of the T belt power control system via a small primary drive sprocket and goes to a much larger sprocket mounted on the boat paddle wheel shaft.

### Example 3

A motorized go-cart is further disclosed as being a go-cart having four wheels on two axels, a steering wheel and seat for the operator and or passenger. A go-cart may be in many configurations and work applications to include light cargo hauling or for people transportation. A small gasoline engine is mounted to the go cart frame. A small four cycle gasoline engine from 30 cc to 200 cc displacement is mounted in the go-cart framework. The T Belt power control system having a centrifugal clutch and primary drive pulley to be installed as an assembly on an engine PTO drive mounting flange. The T belt power control assembly is attached to the engine PTO drive mounting flange with four bolts. A drive chain attaches to the output jackshaft of the power control system via a small primary drive sprocket and goes to a much larger sprocket mounted on the rear drive axle of the go-cart.

### Example 4

A stationary engine work station can be further disclosed as work station requiring small four-cycle engine to turn an axel shaft such as would be typicality found using a circle saw to cut wood but not exclusively. A small four-cycle gasoline engine from 30 cc to 200 cc displacement is mounted on the work station frame. The T belt power control system having a centrifugal clutch and primary drive pulley to be installed as an assembly on an engine PTO output shaft mounting flange. The T belt power control assembly is attached to the engine PTO drive mounting flange with four bolts. A drive chain attaches to the output jackshaft of power control system via a small primary drive sprocket and goes to the intended work load requirement.

What is claimed is:

1. A cylindrical cam lock jackshaft assembly for a timing belt (T-belt) power control system comprising: an off center jackshaft location which in affect provides the tension adjustment for the T-belt (T-belt) by moving a driven pulley away or closer to a stationary drive pulley by using a spanner wrench to move said cam lock assembly in a clockwise or counter clockwise direction.

2. The cylindrical cam lock jackshaft assembly according to claim 1, wherein said cam lock assembly is located in an aluminum alloy cast housing which is attached by four bolts to a small single cylinder horizontal output shaft four-cycle engine which may or may not encompasses an integral centrifugal clutch.

3. The cylindrical cam lock jackshaft assembly according to claim 2, wherein if used with an engine with an integral centrifugal clutch which therefore has the bell drum with drive pulley located in the T belt power control assembly cast aluminum alloy housing having the drive pulley on said bell drum meshing with a T belt, to make a drive train going to a driven pulley with a freewheel bearing hub or solid hub on a shaft with ball bearings being utilized to transmit power in a designed step down speed ratio but not designed exclusively to any certain or exact said step down speed ratio range;

4. The cylindrical cam lock jackshaft assembly according to claim 2, wherein an external centrifugal clutch rotor and external bell drum being attached to an engine output crankshaft transmits engine torque via said external centrifugal clutch to an affixed external bell drum with the drive pulley meshing with a T belt, to make a drive train going to the T-Belt power control system aluminum alloy housing encompassing the driven pulley with a freewheel bearing hub or solid hub on a jackshaft with ball bearings being utilized to transmit power in a designed step down speed ratio but not designed exclusively to any certain or exact said step down speed ratio range;

5. The cylindrical cam lock jackshaft assembly according to claims 3 and 4, wherein said ball bearing supported output jackshaft having the driven pulley to transmit power direct to an affixed output chain sprocket having 9 to 12 teeth.

6. The cylindrical cam lock jackshaft assembly according to claim 5, wherein the driven pulley can have a solid hub or can have a hub with a one-way-freewheel bearing but if with solid hub must have a jackshaft with an output chain sprocket having an internal freewheel so as it can lock in one direction to transmit torque and overrun freely in the opposite direction.
